(19) United States
(12) Patent Application Publication
(10) Pub. No.: US 2010/0300612 A1
(43) Pub. Date: Dec. 2, 2010

(54) WAFER MOUNTING METHOD AND WAFER MOUNTING APPARATUS

(76) Inventors: Masayuki Yamamoto, Osaka (JP); Yukitoshi Hase, Kameyama-shi (JP)

Correspondence Address: Cheng Law Group, PLLC, 1100 17th Street, N.W., Suite 503, Washington, DC, 20036, US

(21) Appl. No.: 12/779,632

(22) Filed: May 13, 2010

(30) Foreign Application Priority Data
May 26, 2009 (JP) 2009-126650

(51) Int. Cl. B32B 38/10; B32B 37/02

(52) U.S. Cl. 156/249; 156/538; 156/378

(57) ABSTRACT

A reinforcing support substrate is joined to a surface of the semiconductor wafer via a double-faced adhesive tape, and then is removed from the semiconductor wafer. Subsequently, the semiconductor wafer with the support substrate removed therefrom is adhesively held on a rear face of a ring frame via a support adhesive tape, and the double-faced adhesive tape is separated from the surface of the semiconductor wafer integrate with the ring frame.

### BACKGROUND OF THE INVENTION

1. Field of the Invention

This invention relates to a wafer mounting method and wafer mounting apparatus for thinning a semiconductor wafer with a reinforcing support substrate joined thereto via a double-faced adhesive tape by a back grinding process, and thereafter adhesively holding the semiconductor wafer on a ring frame via a support adhesive tape.

2. Description of the Related Art

Typically, a circuit pattern with numerous components is formed on a surface of a semiconductor wafer, and then a protective tape is joined to the surface of the wafer for protection. Grinding or polishing is performed in a back grinding process to a rear face of the semiconductor wafer having the protected surface (hereinafter, simply referred to as a “wafer”), thereby obtaining a wafer with a desired thickness. The thinned wafer has a reduced rigidity. Consequently, the wafer with a reinforcing support substrate joined thereto via a double-faced adhesive tape is transported to each process for desired treatment, and subsequently adhesively held on a ring frame via the support adhesive tape (dicing tape). Upon completion of adhesive holding on the ring frame, the support substrate is separated from the surface of the wafer. Thereafter, the double-faced adhesive tape remaining is removed from the surface of the wafer adhesively held, and the wafer with the ring frame is transported to a subsequent dicing process. See, for example, JP2003-347060A.

The above conventional method, however, has the following problem.

Specifically, prior to treatment to the wafer reinforced with the support substrate, the wafer is adhesively held on the ring frame via the support adhesive tape to manufacture a mount frame. Subsequently, the support substrate is firstly removed from the double-faced adhesive tape. Next, the double-faced adhesive tape remaining is separated from the surface of the wafer.

Here, the double-faced adhesive tape has an adhesion layer of thermal foam on a support substrate side thereof. Heating the adhesive layer from the support substrate side for heat foaming may result in adhesion elimination from the double-faced adhesive tape, thereby allowing for removal of the support substrate from the double-faced adhesive tape.

However, upon removal of the support substrate, the heat used for heating the double-faced adhesive tape may also act on the support adhesive tape through which the wafer is adhesively held. As a result, the adhesive tape may be softened and bent. Then, the bent adhesive tape may cause such a problem to reduce a function of the adhesive tape to hold the wafer.

Moreover, when a dicing treatment is applied to the wafer while the adhesive tape is bent, adjacent chips of the divided chips may incline in an approach direction to each other at a portion where the tape is largely bent. Thus, this inclination may lead to problems such as damages at the corner portions of the divided chips and separation of the chips from the adhesive tape, and therefore scattering, due to contact to each other.

### SUMMARY OF THE INVENTION

This invention provides wafer mounting method and apparatus for adhesively holding a wafer with a reinforcing support substrate removed therefrom without bending a support adhesive tape.

Additional features of the invention will be set forth in the description which follows, and in part will be apparent from the description, or may be learned by practice of the invention.

This invention discloses a wafer mounting method for adhesively holding a semiconductor wafer on a ring frame via a support adhesive tape. The method includes the steps of removing a reinforcing support substrate joined to a surface of the semiconductor wafer via a double-faced adhesive tape from the semiconductor wafer, mounting the semiconductor wafer with the support substrate removed therefrom to a rear face of the ring frame via the support adhesive tape for adhesively holding the semiconductor wafer, and separating the double-faced adhesive tape from the surface of semiconductor wafer integral with the ring frame.

With the wafer mounting method, the support substrate may be removed from the semiconductor wafer prior to adhesive holding to the support adhesive tape. Consequently, the adhesive tape will never be influenced by heat from a heat treatment for eliminating or sufficiently reducing adhesive force in the double-faced adhesive tape in the support substrate removing step. Specifically, the adhesive tape may be prevented from being softened and bent due to the heat. Consequently, damages or scattering due to contact of the chips divided by dicing in a subsequent process at the corners thereof may be suppressed.

The method further includes the steps of transporting the semiconductor wafer while holding in a planar state onto an aligner from a side of the double-faced adhesive tape that remains on the surface of the semiconductor wafer with the support substrate removed therefrom in a planar state on a removing table in the support substrate removing step, aligning the semiconductor wafer received on the aligner while holding in a planar state for performing alignment, feeding the semiconductor wafer to a chuck table while holding in a planar state on the aligner, and receiving the semiconductor wafer from the aligner to the chuck table while holding in a planar state to transport the semiconductor wafer to the mounting step.

According to this method, even when the support substrate is removed to obtain the semiconductor wafer having only the adhesive tape with lower rigidity, the semiconductor wafer may be processed in a planar state from prior to removal until adhesive holding of the support substrate to the ring frame.

Consequently, the adhesive tape may suitably be joined over the semiconductor wafer and ring frame with no warping deformation.

In the above method, it is preferable to remove the support substrate from the semiconductor wafer as follows in the support substrate removing step.

That is, the double-faced adhesive tape with at least one of adhesion layers sandwiching a base material formed of an adhesive of thermal foam is suction-held and heated on the removing table with an integrated heater from the support substrate side, and the removing table moves upward to remove the support substrate from the semiconductor wafer.

In the above method, the support substrate may be removed from the semiconductor wafer with the double-faced adhesive tape remaining on the surface thereof. Here, the double-faced adhesive tape serves as a surface protection tape on the semiconductor wafer.

This invention also discloses a wafer mounting apparatus for adhesively holding a semiconductor wafer on a ring frame via a support adhesive tape, including a removing table to adhesively hold the semiconductor wafer on a support substrate via a double-faced adhesive tape, a substrate removing device to remove the support substrate with the double-faced adhesive tape remaining on the semiconductor wafer, a wafer transport mechanism to transport the semiconductor wafer held on the removing table in a planar state, an aligner to align the semiconductor wafer in a planar state that is transported by the wafer transport mechanism, a chuck table to receive the semiconductor wafer transported together with the aligner in a planar state, a joining mechanism to join the support adhesive tape over the semiconductor wafer held by the chuck table and the ring frame, and a tape separation mechanism to separate the double-faced adhesive tape from the semiconductor wafer integral with the ring frame via the adhesive tape.

With this configuration, the semiconductor wafer may be processed and transported as desired in a planar state from prior to removal of the support substrate from the semiconductor wafer that is adhesively held on the support substrate via the double-faced adhesive tape until adhesive holding on the ring frame after the removal.

With this configuration, the separation table is preferably configured so as to move from a removing position where the support substrate is to be removed to a wafer transporting position where the semiconductor wafer is to be transported to the wafer transport mechanism.

This configuration may realize appropriate transportation of the semiconductor wafer into the substrate removing device prior to removal of the support substrate and transportation from the substrate removing device after the removal.

Moreover, the wafer transporting mechanism includes a pressure plate to act on the semiconductor wafer. The aligner includes a detector to detect suction on the rear face of the semiconductor wafer, and a determination device to determine flatness of the semiconductor wafer in accordance with detected information from the detector and reference information set in advance. Here, upon detection of warping in the semiconductor wafer with the determination device, the semiconductor wafer is preferably corrected to be in a planar state by pressing the pressure plate of the wafer transporting mechanism against the semiconductor wafer.

With this configuration, the thinned semiconductor wafer having reduced rigidity due to removal of the support substrate may be processed with no warping deformation. Moreover, the support adhesive tape may suitably be joined over the semiconductor wafer and ring frame.

Further, according to this configuration, it is preferable to form at least one of the adhesion layers in the double-faced adhesive tape with an adhesive of thermal foam. In addition, the substrate removing device preferably has a heater for heating the double-faced adhesive tape.

With this configuration, heating of the double-faced adhesive tape may cause the adhesive layer therein to be thermally foamed, thereby eliminating or sufficiently suppressing the adhesive force readily. Particularly, the support substrate may readily be removed from the semiconductor wafer by holding the support substrate with such an adhesive layer of thermal foam.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is an overall perspective view of a wafer mounting device.

FIG. 2 is a plan view showing a substrate removing device.

FIG. 3 is a side view showing the substrate removing device.

FIG. 4 is a front view around a separation table of the substrate removing device.

FIG. 5 is a front view showing variations of a semiconductor wafer subject to each process.

FIGS. 6 to 9 are front views each showing a support substrate removing process.

FIG. 10 is a perspective view of a mount frame with the surface of the wafer being exposed.

### DESCRIPTION OF THE PREFERRED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

One exemplary embodiment of this invention will be described in detail hereinafter with reference to the drawings.

A water mounting apparatus 1 of this embodiment includes a wafer supply section 2 with a cassette C1 placed therein to house a semiconductor wafer (hereinafter, simply referred to as a “wafer W”) to which a back grinding process has been performed in a stack manner, a wafer transport mechanism 3 with a robot arm 4 and a pressing mechanism 5, a substrate removing device 10 to remove a reinforcing support substrate P joined to a surface of the wafer W, an aligner 7 to perform alignment of the wafer W, an ultraviolet irradiation unit 14 to irradiate the wafer W held on the alignment stage 7 with ultraviolet rays, a chuck table 15 to suction-hold the wafer W, a ring frame supply section 16 in which a ring frame f is housed in a stack manner, a ring frame transport mechanism 17 to move and mount the ring frame f onto a support adhesive tape DT, a tape processing section 18 to join the adhesive tape DT to a rear face of the ring frame f, a ring frame lifting mechanism 26 to move the ring frame f vertically with the adhesive tape DT joined thereto, a mount frame manufacturing section 27 to manufacture a mount frame MF produced in one piece by joining the wafer W to the ring frame f with the adhesive tape DT joined thereto, a first mount frame transport mechanism 29 to transport the manufactured mount frame MF, a separating mechanism 30 to separate a double-faced adhesive tape BT remaining on the surface of the wafer W, a second mount frame transport mechanism 35 to transport the mount frame MF with the protective tape PT separated therefrom with the separation mechanism 30, a turntable 36 to turn and transfer the mount frame MF, and a mount frame collecting section 37 to collect the mount frame MF in a stack manner. Description will be made in detail hereinafter of the configurations of each component mentioned above.

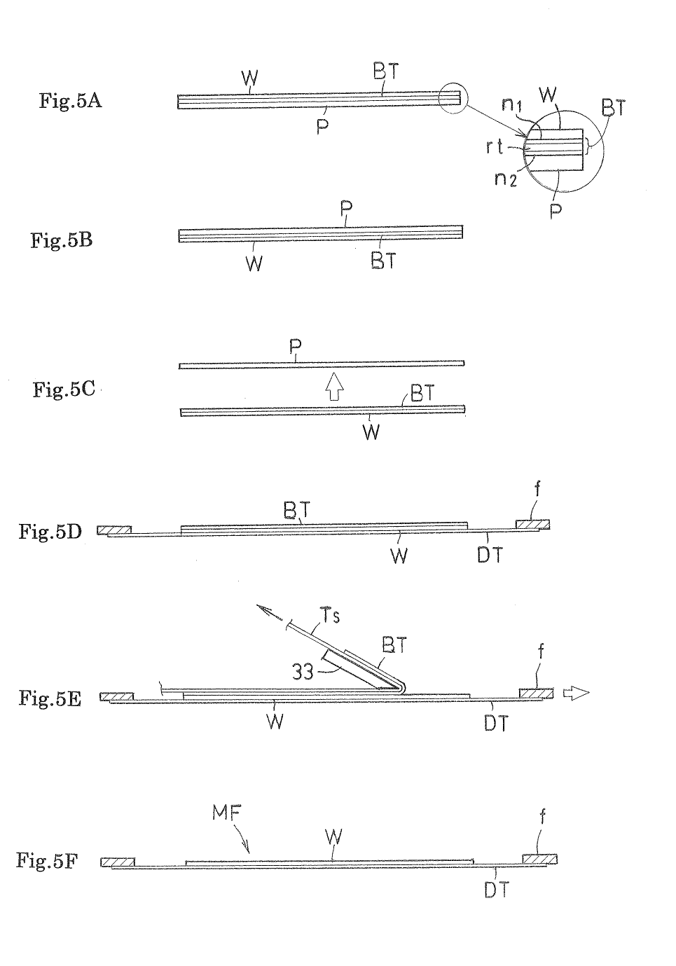

The wafer supply section 2 includes a cassette table not shown. The cassette C1 to house the wafers W to which the back grinding has been performed in a stack manner is placed on the cassette table. Here, as illustrated in FIG. 5A, the wafer W to be housed has a pattern formation surface (hereinafter appropriately referred to as a “surface”) with the support substrate P having higher rigidity such as a glass plate joined thereto via the reinforcing double-faced adhesive tape BT. The wafer W is housed with the support substrate P directed downward. Moreover, as illustrated in an enlarged portion of FIG. 5A, the double-faced adhesive tape BT has an ultraviolet curable adhesion layer n1 on one surface of a tape base material rt, and an adhesive layer n2 of thermal foam on the other surface thereof. The wafer W is joined to the adhesive layer n1, and the support substrate to the adhesive layer n2.

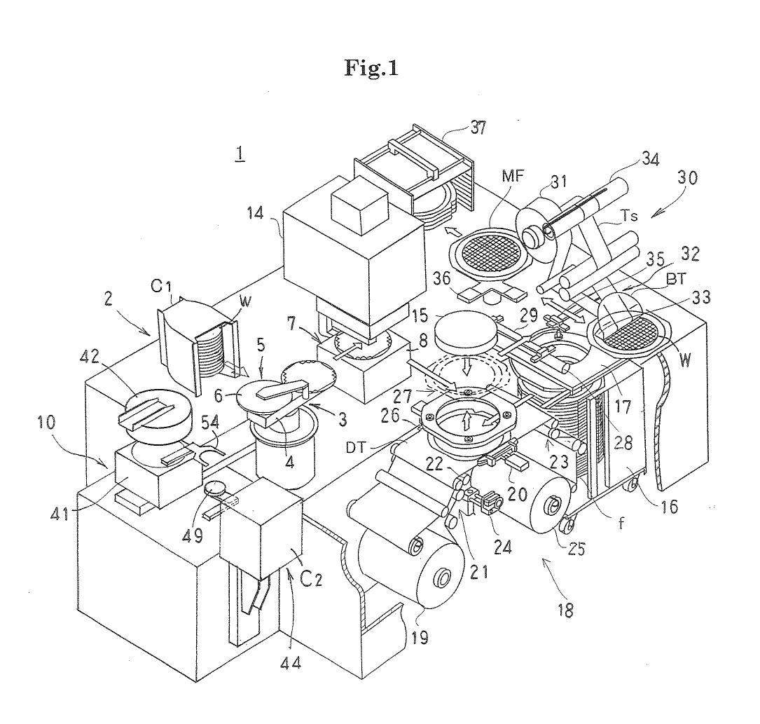

Now, referring again to FIG. 1, the wafer transport mechanism 3 turns and moves vertically with a drive mechanism not shown. Specifically, the wafer transport mechanism 3 performs positioning of a wafer holder of the robot arm 4 and a pressure plate 6 provided in the pressing mechanism 5, mentioned later. Moreover, the wafer transport mechanism 3 pulls out the wafer W from the cassette C1 or the substrate removing device 10, and transports the wafer W to the aligner 7 or the substrate removing device 10.

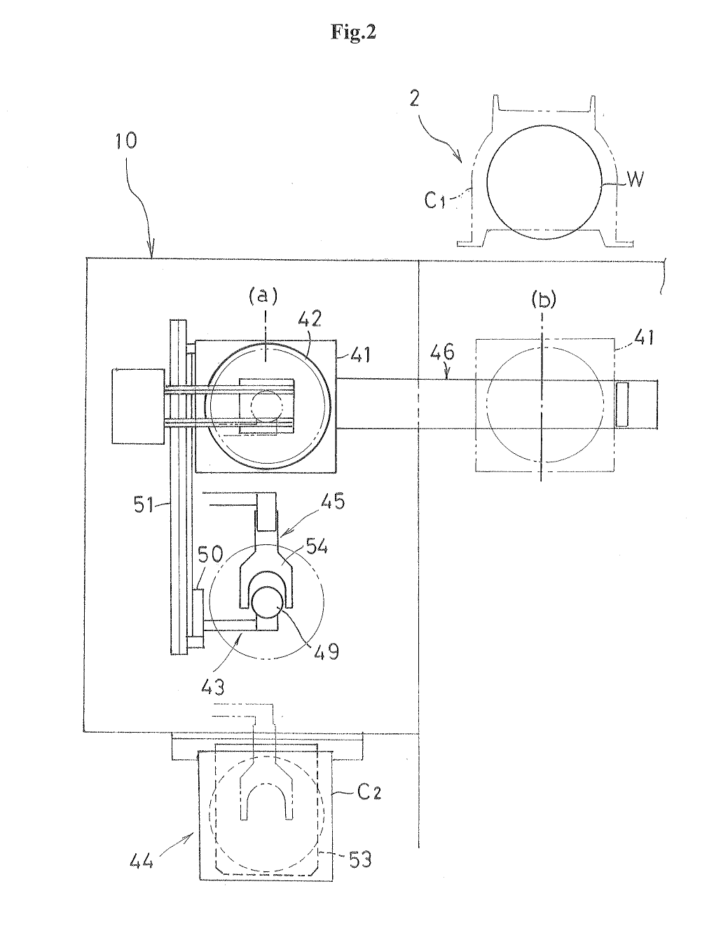

As illustrated in FIGS. 2 to 4, the substrate removing device 10 is placed close to the wafer supply section 2 and wafer transport mechanism 3 on a lateral side of the wafer mounting apparatus 1. The substrate removing device 10 has a removing table 41, a removing stage 42 capable of moving vertically, a first substrate transport mechanism 43, a substrate collecting section 44, and a second substrate transport mechanism 45. The removing table 41 may reciprocate horizontally with the wafer W placed thereon. The first substrate transport device 43 receives the removed support substrate P to transport the substrate P horizontally to a given transporting position d. The second substrate transport device 45 receives the support substrate P from the first substrate transport device 43, and transports the support substrate P to the substrate collecting section 44.

The removing table 41 reciprocates horizontally through a guide drive mechanism 46 using a rod less cylinder. Specifically, the removing table 41 is configured so as to move from a removing position a where the support substrate P is to be removed to a wafer transporting position b where the wafer W is to be transported to the wafer transport mechanism 3. The removing table 41 has an upper surface formed as a vacuum suction surface capable of suction holding the wafer W in a planar state.

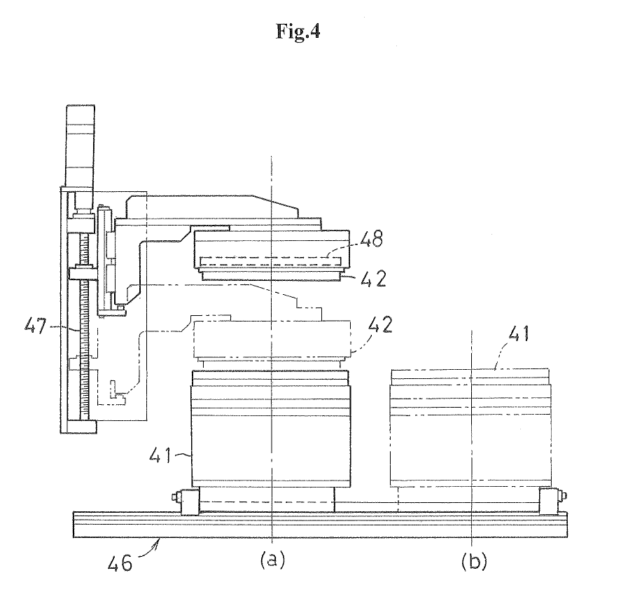

As illustrated in FIG. 4, the removing stage 42 drives vertically via a motor-driven screw shaft 47 above the removing table in the removing position a. The separation stage 42 has an under surface formed as a vacuum suction surface. The separation stage 42 also has a heater 48 integrated therein.

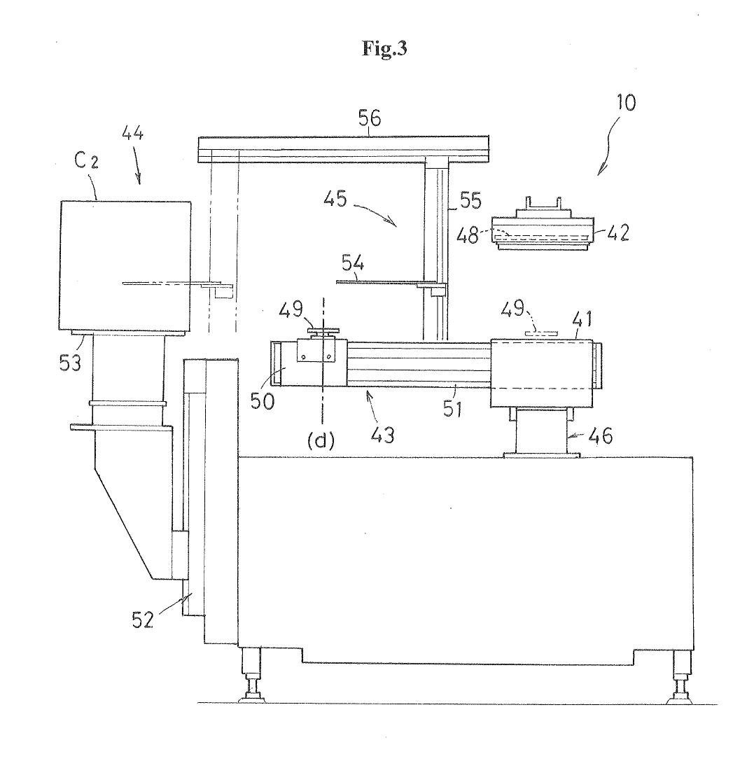

As illustrated in FIGS. 2 and 3, the first transport mechanism 43 has a suction pad 49, a movable table 50, and a back and forth drive mechanism 51. The suction pad 49 has an upper surface formed as a vacuum suction surface. The movable table 50 supports the suction pad 49. The back and forth drive mechanism 51 reciprocates the movable table 50 backward and forward using a rod less cylinder. That is, when the back and forth drive mechanism 51 reaches at a forward movement limitation position, a center of the suction pad 49 corresponds to a center of the removing position a, whereas when the back and forth drive mechanism 51 reaches at a backward movement limitation position, the center of the suction pad 49 corresponds to a center of the transporting position d.

The substrate collecting section 44 is configured so as to transport and mount the cassette C2 for collecting the substrate on a lifting table 53 capable of moving vertically by a lifting mechanism 52 that is driven by a motor in a screw feed manner. The cassette C2 has the support substrate P inserted therein in a stack manner and is loaded with a front face thereof open toward the second transport mechanism 45.

The second transport mechanism 45 has a substrate holder 54, a vertical drive mechanism 55, and a back and forth drive mechanism 56. The substrate holder 54 is U-shaped with a top surface thereof formed as a vacuum suction surface. The vertical drive mechanism 55 moves the substrate holder 54 vertically in a screw feed manner. The back and forth drive mechanism 56 moves the vertical drive mechanism 55 entirely using a rod less cylinder.

Next, referring to FIG. 1, the robot arm 4 of the wafer transport mechanism 3 has at its tip end a U-shaped wafer holder, not shown. The robot arm 4 is configured such that the wafer holder may move backward and forward between the wafers W housed in the cassette C1 in a stack manner. Here, the wafer holder at the tip end of the robot arm 4 has a vacuum suction surface to perform vacuum suction on the rear face of the wafer W.

The pressing mechanism 5 of the wafer transport mechanism 3 has at its end the circular pressure plate 6 of an approximately similar shape to the wafer W. The robot arm 4 moves backward and forward such that the pressure plate 6 moves above the wafer W placed on the holding table 8 of the aligner 7.

The pressing mechanism 5 operates in poor suction of the wafer W upon placing the wafer W on the holding table 8 of the aligner 7 mentioned later. Specifically, where the wafer W cannot be suction-held due to warping thereof, the pressure plate 6 presses the surface of the wafer W to correct the warping, allowing the wafer to be planar. The holding table 8 performs vacuum suction on the rear face of the wafer W under this state.

The aligner 7 performs alignment of the placed wafer W based on an orientation mark or a notch formed at an outer periphery of the wafer W. The aligner 7 includes the holding table 8 to cover the entire rear face of the wafer W for performing vacuum suction.

The aligner 7 measures a pressure value when performing vacuum suction on the wafer W, and compares the measured pressure value with a predetermined reference value in relation to a pressure value in a normal operation (when the holding table 8 normally performs suction on the wafer W). When the pressure value detected is higher than the reference value (that is, a pressure in a suction hole of the aligner 7 is not sufficiently reduced), it is determined that the holding table 8 fails to perform suction on the wafer W due to warping thereof. Subsequently, the pressure plate 6 operates to press the wafer W and correct the warping thereof, allowing the holding table 8 to perform suction on the wafer W normally.

The aligner 7 may move so as to transport the wafer W in a suction-held state from an initial position where the wafer W is placed to perform alignment to an intermediate position between the chuck tables 15 above the tape processing section 18 mentioned later and the ring frame lifting mechanism 26. In other words, the aligner 7 transports the wafer W to the subsequent process in a planar state with the warping thereof being corrected.

An ultraviolet irradiation unit 14 is provided above the aligner 7 in the initial position. The ultraviolet irradiation unit 14 irradiates the double-faced adhesive tape BT joined to the surface of the wafer W with ultraviolet rays, thereby softening the adhesive layer n1 joined to the wafer W to reduce an adhesive strength thereof.

The chuck table 15 has a circular shape approximately similar to the wafer W so as to cover the surface of the wafer W for performing vacuum suction. The chuck table 15 moves vertically with the drive mechanism not shown from a standby position above the tape processing section 18 to a position of joining the wafer W to the ring frame f.

The chuck table 15 contacts and suction-holds the wafer W held in a planar state with the warping thereof corrected by the holding table 8.

The chuck table 15 is received into an opening of the ring frame lifting mechanism 26, mentioned later, to suction-hold the ring frame f with the adhesive tape DT joined to the rear face thereof, and the wafer W is moved downward to a position adjacent the adhesive tape DT on the underside of the ring frame f.

Here, a holding mechanism, not shown, holds the chuck table 15 and ring frame lifting mechanism 26.

The body of the device houses the ring frame supply unit 16 in a wagon shape having pulleys on the bottom thereof. The ring frame supply unit 16 has an opening on an upper side thereof to slidably moves upward and feed out the ring frame f housed therein in a stack manner.

The ring frame transport mechanism 17 performs vacuum suction on every one ring frame f housed in the ring frame supply unit 16 in turn from the top, and transports the ring frame f to an aligner not shown and the position of joining the adhesive tape DT, in turn. The ring frame transport mechanism 17 serves as a holding mechanism to hold the ring frame f in the position of joining the adhesive tape DT upon joining of the adhesive tape DT.

The tape processing section 18 includes a tape supply unit 19, a tension mechanism 20, a joining unit 21, a cutter mechanism 24, a separating unit 23, and a tape collecting section 25. The tape supply unit 19 supplies the adhesive tape DT. The tension mechanism 20 applies tension to the adhesive tape DT. The joining unit 21 joins the adhesive tape DT to the ring frame f. The cutter mechanism 24 circularly cuts the adhesive tape DT joined to the ring frame f. The separating unit 23 separates an unnecessary tape DT cut with the cutter mechanism 24 from the ring frame f. The tape collecting section 25 collects the remainder of the cut unnecessary tape DT.

The tension mechanism 20 sandwiches the adhesive tape DT on opposite ends in a width direction to apply tension to the adhesive tape DT in a tape width direction. When a soft adhesive tape DT is used, tension applied in a tape supply direction may cause occurrence of a longitudinal wrinkle on the surface of the adhesive tape DT along the tape supply direction. In order to avoid the longitudinal wrinkle so as to join the adhesive tape DT uniformly to the ring frame f, tension is applied on the opposite ends in the tape width direction.

The joining unit 21 is placed obliquely downwardly from the ring frame f above the adhesive tape DT, i.e., in the standby position. The joining unit 21 has a joining roller 22. The ring frame transport mechanism 17 holds to transport the ring frame f into the joining position. Subsequently, the tape supply unit 19 starts to supply the adhesive tape DT, and simultaneously the joining roller 22 moves to a joining start position on the right of the tape supply direction.

When reaching at the joining start position, the joining roller 22 moves upward to press and join the adhesive tape DT onto the ring frame f. Subsequently, the joining roller 22 rolls from the joining start position toward the standby position, thereby joining the adhesive tape DT to the ring frame f while pressing.

The separation unit 23 separates the unnecessary portion of the adhesive tape DT cut with the cutter mechanism 24 mentioned later from the ring frame f. Specifically, after joining the adhesive tape DT to the ring frame f and cutting the adhesive tape DT, the tension mechanism 20 releases holding of the adhesive tape DT. Subsequently, the separation unit 23 moves on the ring frame f toward the tape supply section 19, thereby separating the cut unnecessary adhesive tape DT.

The cutter mechanism 24 is placed below the adhesive tape DT with the ring frame f placed thereon. When the joining unit 21 joins the adhesive tape DT to the underside of the ring frame f, the tension mechanism 20 releases holding of the adhesive tape DT, and consequently the cutter mechanism 24 moves upward. The cutter mechanism 24 after moving upward cuts the adhesive tape DT circularly along the ring frame f.

The ring frame lifting mechanism 26 is usually in the standby position above a position of joining the adhesive tape DT to the ring frame f. After joining of the adhesive tape DT to the ring frame f, the ring frame lifting mechanism 26 moves downward to suction-hold the ring frame f. At this time, the ring frame transport mechanism 17 holding the ring frame f returns to its initial position above the ring frame supply unit 16.

After performing vacuum suction on the ring frame f, the ring frame lifting mechanism 26 moves the ring frame f to the joining position to the wafer W. At this time, the chuck table 15 suction holding the wafer W moves downward to the joining position to the wafer W.

The mount frame manufacturing section 27 has a joining roller 28 with an outer peripheral surface that is elastically deformable. The joining roller 28 rolls on a non-adhesive surface of the adhesive tape DT joined to the rear face of the ring frame f while pressing.

The first mount frame transport mechanism 29 performs vacuum suction on the mount frame MF that the ring frame f is formed in one piece with the wafer W, and moves to mount the mount frame MF onto the separation table of the separation mechanism 30 not shown.

The separating mechanism 30 includes a separation table not shown, a tape supply section 31, a separating unit 32, and a tape collecting section 34. The separation table moves the wafer W mounted thereon. The tape supply section 31 supplies a narrow separation tape Ts. The separation unit 32 joins and separates the separation tape Ts. The tape collecting section 34 collects the separated separation tape Ts and the double-faced adhesive tape BT. The separation unit 32 has a joining member 33 having a plate wider than the ring frame f with a tip end thereof formed into an edge of a knife. That is, the separation unit 32 joins the separation tape Ts to the double-faced adhesive tape BT on the surface of the wafer, and folds back the separation tape Ts at the edge for guiding.

The tape supply section 31 guides and supplies the separation tape Ts fed out from a master roll to the joining member 33 provided on a lower side of the separation unit 32.

The tape collecting section 34 winds up and collects the separation tape Ts fed out from the separation unit 32.

The second mount frame transport mechanism 35 performs vacuum suction on the mount frame MF fed out from the separating mechanism 30, and moves to mount the mount frame MF onto a turntable 36.

The turntable 36 aligns the mount frame MF, and houses the mount frame MF in the mount frame collecting section 37. Specifically, the second mount frame transport mechanism 35 places the mount frame MF on the turntable 36, and then aligns the mount frame MF based on an orientation mark of the wafer W or a positioning contour of the ring frame f. The turntable 36 turns so as to change a direction where the mount frame MF is to be housed in the mount frame collecting section 37. When the direction for housing the mount frame MF is fixed, the turntable 36 presses out the mount frame MF with a pusher not shown to house the mount frame MF in the mount frame collecting section 37.

The mount frame collecting section 37 is placed on a mount table not shown capable of moving vertically. Specifically, moving vertically of the mount table allows the mount frame MF pressed out with the pusher to be housed on any sections in the mount frame collecting section 37.

Description will be made hereinafter of a round of operation about the above-mentioned apparatus according to one embodiment.

The wafer holder of the robot arm 4 in the wafer transport mechanism 3 is inserted between the stacked wafers W in the cassette C1. The wafer W with the support substrate P directed upward is suction-held on the rear face thereof, and pulled out for every one sheet. The robot arm 4 transports the pulled out wafer W to the aligner 7 with the support substrate P directed upward.

Upon completion of the alignment with the aligner 7, the robot arm 4 pulls out the wafer W again, and moves and places the wafer W on the removing table 41 on standby in the wafer transporting position b. The removing table 41 suction-holding the placed wafer W moves to the removing position a.

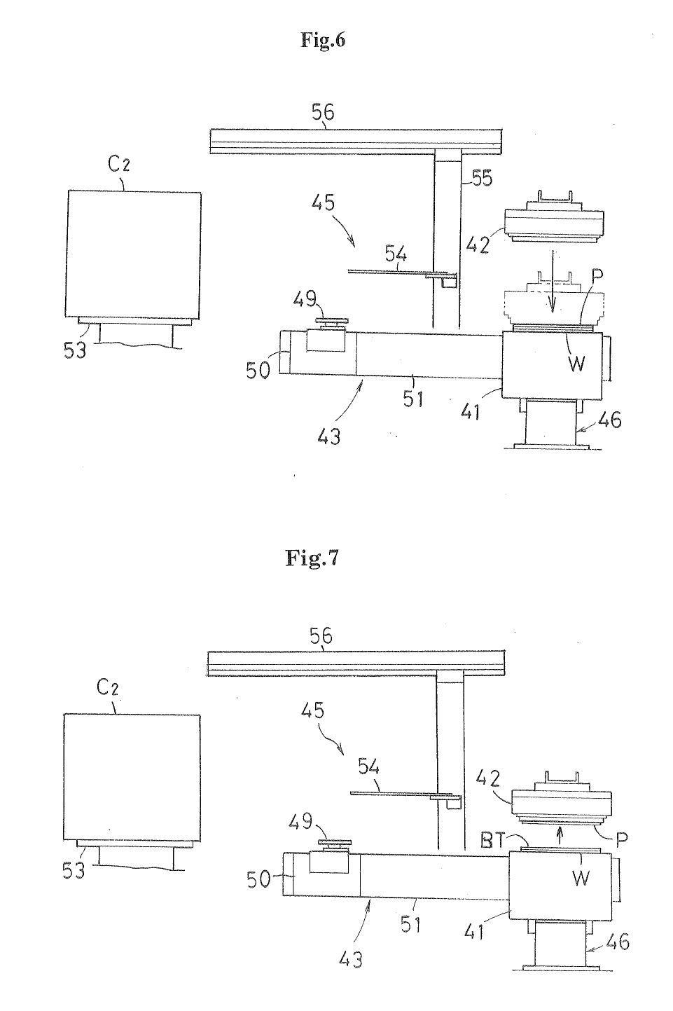

As illustrated in FIG. 6, the removing table 41 reaches at the removing position a, and then the removing stage 42 on standby in the upper side moves downward. The removing stage 42 presses and contacts the support substrate P on the under surface thereof, and suction-holds the support substrate P. With such pressing and contacting, the heat from the heater 48 in the removing stage 42 is transmitted to the double-faced adhesive tape BT through the support substrate P. That is, the adhesion layer n2 of thermal foam is heated that adhesively holds the support substrate P. The heat may allow the adhesive layer n2 to be thermally foamed, thereby eliminating or sufficiently suppressing the adhesive force thereof.

Next, as illustrated in FIG. 7, the removing stage 42 moves upward. As illustrated in FIG. 5C, the support substrate P suction-held on the under surface of the removing stage 42 is moved downward with the double-faced adhesive tape BT remaining on the wafer W. Consequently, the wafer W with the double-faced adhesive tape BT joined thereto remains on the removing table 41.

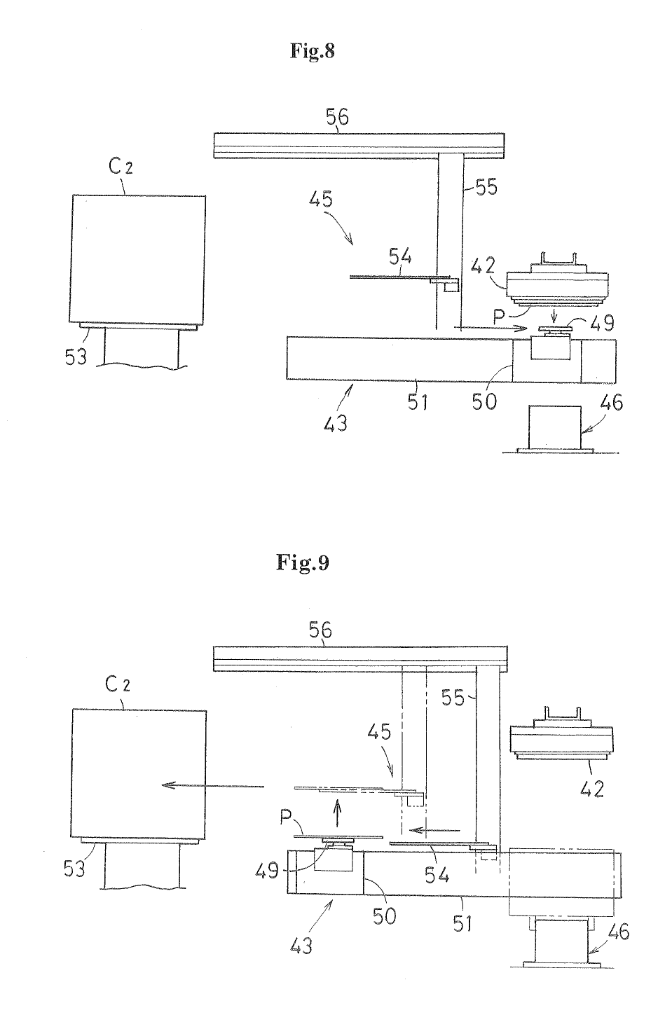

Upon lifting of the support substrate P while suction-holding with the removing stage 42, the removing table 41 holding the wafer W moves towards the wafer transporting position b, and the suction pad 49 of the first substrate transport mechanism 43 moves forward to the removing position a, as illustrated in FIGS. 2 and 8.

When the suction pad 49 reaches at the removing position a, the removing stage 42 moves downward. The removing stage 42 places the support substrate P suction-held on the under surface thereof on the suction pad 49. Simultaneously, the removing stage 42 releases vacuum suction, and the suction pad performs vacuum suction. That is, transportation of the support substrate P is completed from the removing stage 42 to the suction pad 49.

Upon completion of the substrate transportation from the removing stage 42 to the suction pad 49, the removing stage 42 moves upward to return to its original standby position, and the suction pad 49 with the support substrate P suction-held thereon moves backward to the substrate transporting position d (see FIG. 3.)

Next, the substrate holder 54 of the second substrate transport mechanism 45 moves to stay under the support substrate P suction-held on the suction pad 49. Subsequently, the substrate holder 54 moves upward. Here, the substrate holder 54 holds up the support substrate P from the suction pad with released vacuum suction, and sucks the support substrate P on the upper face thereof. When the substrate holder 54 with the support substrate P suction-held thereon moves upward to a predetermined level, the substrate holder 54 moves horizontally towards the substrate collecting section 44 to insert the support substrate P into a specified section in the cassette C2. When the support substrate P reaches on the specified section, the substrate holder 54 releases its vacuum suction and pulls out. The collection of the removed support substrate P is completed as mentioned above.

When the removing table 41 that holds the wafer W with the support substrate P removed therefrom reaches at the wafer transporting position b, the robot arm 4 again suction-holds the double-faced adhesive tape BT on the surface of the wafer W. Here, the robot arm 4 suction-holds the surface of the wafer W that is suction-held in a planar state by the removing table 41, and thereafter, releases the suction holding of the removing table 41.

The robot arm 4 places the wafer W on the holding table 8 of the aligner 7 to suction-hold the rear face of the wafer W. Also in this state, the holding table 8 performs suction, and subsequently the robot arm 4 releases its suction holding. Here, a pressure gauge, not shown, measures a level of suction-holding the wafer W upon transporting of the wafer W on the holding table 8. A comparison is made of an actual measured value and a reference value set in advance in relation to a pressure value in a normal operation.

When poor suction holding is detected from the result of the comparison, the pressure plate 6 presses the surface of the wafer W. Consequently, the wafer W in a planar state with corrected warping may be suction-held. In addition, the wafer W is aligned again based on the orientation mark or the notch.

After alignment of the wafer W on the aligner 7, the ultraviolet irradiation unit 14 irradiates the surface of the wafer W with ultraviolet rays. Consequently, the adhesive layer n1 of the double-faced adhesive tape BT cures, which leads to reduced adhesive force thereof.

The wafer W subjected to an irradiation treatment of ultraviolet rays is transported to the mount frame-manufacturing unit 27 at a subsequent step while being suction-held by the holding table 8. That is, the holding table 8 moves to an intermediate position between the chuck table 15 and the ring frame lifting mechanism 26.

When the holding table 8 is on standby in a predetermined position, the chuck table 15 located above the holding table 8 moves downward to contact a bottom face thereof with the wafer W (strictly the upper face of the double-faced adhesive tape BT), thereby starting vacuum suction. When the chuck table 15 starts vacuum suction, the holding table 8 releases its suction holding of the wafer W. The chuck table 15 receives the wafer W in a planar state with corrected warping. After transporting the wafer W, the holding table 8 returns to its initial position.

Next, the ring frame transport mechanism 17 performs vacuum suction on every ring frame f from the top that is housed in the ring frame supply section 16 in a stack manner, and then pulls out the ring frame f. The pulled-out ring frame f is aligned on an alignment stage not shown, and then transported to a tape joining position above the adhesive tape DT.

The ring frame transport mechanism 17 holds the ring frame f and moves the ring frame f into the joining position of the adhesive tape DT, and then a tape supply section 19 starts to supply the adhesive tape DT. Simultaneously, the joining roller 22 moves into a joining start position.

When the joining roller 22 reaches at the joining start position, the tension mechanism 20 holds the opposite ends of the adhesive tape DT in the width direction, thereby applying tension to the adhesive tape DT in the tape width direction.

Next, the joining roller 22 moves upward to press and join the adhesive tape DT onto the end of the ring frame f. After joining the adhesive tape DT to the end of the ring frame f, the joining roller 22 rolls toward the tape supply section 19, i.e., to a standby position. Here, the joining roller 22 rolls while pressing the non-adhesive surface of the adhesive tape DT, thereby joining the adhesive tape DT to the ring frame f. When the joining roller 22 reaches at its joining termination position, the tension mechanism 20 releases holding of the adhesive tape DT.

Simultaneously, the cutter mechanism 24 moves upward to cut the adhesive tape DT circularly along the ring frame f. Upon completion of cutting the adhesive tape DT, the separation unit 23 moves toward the tape supply section 31, thereby separating the unnecessary adhesive tape DT.

Subsequently, the tape supply section 19 operates to feed out the adhesive tape DT while feeding out the unnecessary tape to the tape collecting section 25. In this state, the joining roller 22 moves into the joining start position so as to join the adhesive tape DT to a next ring frame f.

The ring frame lifting mechanism 26 moves upward while suction holding a frame portion of the ring frame f with the adhesive tape DT joined thereto. Here, the chuck table 15 also moves downward. That is, the chuck table 15 and the ring frame lifting mechanism 26 each move into the joining position of the wafer W.

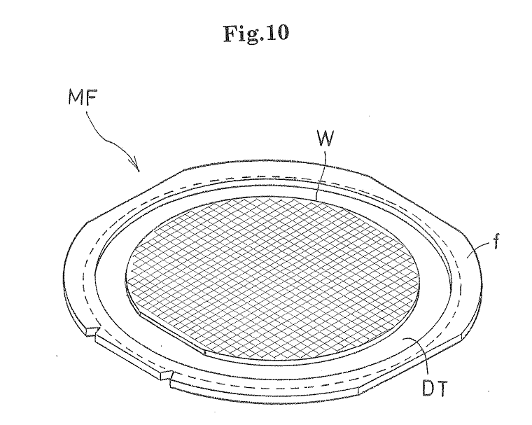

Upon reaching at a predetermined position, each of the chuck table 15 and the ring frame lifting mechanism 26 is held with a holding mechanism not shown. Next, the joining roller 28 moves into a joining start position of the adhesive tape DT. The joining roller 28 rolls while pressing the non-adhesive surface of the adhesive tape DT joined to the rear face of the ring frame f, thereby joining of the adhesive tape DT to the wafer W. Consequently, the mount frame MF that the ring frame f and the wafer W are formed in one piece may be manufactured, as illustrated in FIG. 10.

After manufacturing of the mount frame MF, the chuck table 15 and the ring frame lifting mechanism 26 move upward. The holding table not shown also moves below the mount frame MF and places the mount frame MF thereon. The first mount frame transport mechanism 29 suction-holds the placed mount frame MF, and moves to place the mount frame MF onto the separation table.

The mount frame MF is horizontally moved into a predetermined position while being held by the separation table. In the predetermined position, the joining member 33 moves downward with the separation tape Ts supplied from the tape supply section being wound, and the tip end of the joining member 33 presses the separation tape Ts against a front upper surface of the double-faced adhesive tape BT at a given pressure. Consequently, the separation tape Ts is joined to the double-faced adhesive tape BT.

Next, with the separation tape Ts pressed against the double-faced adhesive tape BT at the tip end of the joining member 33, the mount frame MF starts to be moved forward again and the separation tape Ts is wound up to the tape collecting section 34 at a speed synchronized to a traveling speed of the mount frame MF. Consequently, as illustrated in FIG. 5E, the joining member 33 joins the separation tape Ts to the double-faced adhesive tape BT on the surface of the wafer W while pressing. Simultaneously, the joining member 33 separates the double-faced adhesive tape BT from the surface of the wafer W together with the separation tape Ts.

When the joining member 33 reaches at a rear end edge of the double-faced adhesive tape BT, the double-faced adhesive tape BT is completely separated from the surface of the wafer W. Here, the joining member 33 moves upward and the separation unit 32 returns to its initial state.

After the double-faced adhesive tape BT is separated, the separation table moves the mount frame MF with the exposed surface to the standby position of the second mount frame transport mechanism 35.

Subsequently, the second mount frame transport mechanism 35 moves to place the mount frame MF fed out from the separation mechanism 30 onto the turntable 36. The placed mount frame MF is aligned using the orientation mark or the notch, and a direction is controlled where the mount frame MF is to be housed. After performing alignment of the mount frame MF and determination in the direction thereof to be housed, the pusher not shown pushes out the mount frame MF to house in the mount frame collecting section 37. Thus, a round of operation is completed as mentioned above.

According to the exemplary embodiment described above, the substrate removing device 10 removes the support substrate P from the wafer W in the step prior to adhesively holding the wafer W on the adhesive tape DT. Specifically, the adhesive tape DT may be prevented from being softened and bent due to the heat. Consequently, damages or scattering due to contact of the chips divided by dicing in a subsequent process at the corners thereof may be suppressed.

The wafer W pulled out from the cassette C1 is transported in a planar state from completion of removing the support substrate P until transportation to the chuck table 15 to be integrated with the ring frame f via the adhesive tape DT. Consequently, the wafer W with the adhesive tape joined thereto that has reduced rigidity due to removal of the support substrate may suitably be joined over the wafer W and ring frame f with no warping deformation.

Exemplary embodiments of this invention may be implemented in the following forms.

(1) In the exemplary embodiment described above, a single removing stage 42 provided with the heater 48 performs heating of the double-faced adhesive tape BT as well as suction holding and removing of the support substrate P. Alternatively, heating of the double-faced adhesive tape BT and removing of the support substrate P may be performed in a separate process.

(2) The substrate removing device 10 described above may also be detached from the body of the device. That is, the substrate removing device 10 may be operated as a wafer mounting apparatus so as to manufacture a mount frame MF using a wafer W with a protective tape having an ultraviolet curable adhesion layer as a base material sheet joined to the surface of thereof.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A method of mounting a semiconductor wafer on a ring frame via a support adhesive tape for adhesively holding the semiconductor wafer, comprising the steps of:
removing a reinforcing support substrate joined to a surface of the semiconductor wafer via a double-faced adhesive tape from the semiconductor wafer;
mounting the semiconductor wafer with the support substrate removed therefrom to a rear face of the ring frame via the support adhesive tape for adhesively holding the semiconductor wafer; and
separating the double-faced adhesive tape from the surface of semiconductor wafer integral with the ring frame.

2. The method of mounting the semiconductor wafer according to claim 1, further comprising the steps of:
transporting the semiconductor wafer while holding in a planar state onto an aligner from a side of the double-faced adhesive tape that remains on the surface of the semiconductor wafer with the support substrate removed therefrom in a planar state on a removing table in the support substrate removing step;
aligning the semiconductor wafer received on the aligner while holding in a planar state for performing alignment,
feeding the semiconductor wafer to a chuck table while holding in a planar state on the aligner; and
receiving the semiconductor wafer from the aligner to the chuck table while holding in a planar state to transport the semiconductor wafer to the mounting step.

3. The method of mounting the semiconductor wafer according to claim 1, wherein
in the step of removing the substrate, the double-faced adhesive tape with at least one of adhesion layers sandwiching a base material formed of an adhesive of thermal foam is suction-held and heated on the removing table with an integrated heater from a support substrate side, and the removing table moves upward to remove the support substrate from the semiconductor wafer.

4. The method of mounting the semiconductor wafer according to claim 3, wherein
the support substrate is removed from the semiconductor wafer with the double-faced adhesive tape remaining on the surface thereof.

5. An apparatus for mounting a semiconductor wafer for adhesively holding the semiconductor wafer on a ring frame via a support adhesive tape, comprising:
a removing table to adhesively hold the semiconductor wafer on a support substrate via a double-faced adhesive tape;
a substrate removing device to remove the support substrate with the double-faced adhesive tape remaining on the semiconductor wafer;
a wafer transport mechanism to transport the semiconductor wafer held on the removing table in a planar state;
an aligner to align the semiconductor wafer in a planar state that is transported by the wafer transport mechanism;
a chuck table to receive the semiconductor wafer transported together with the aligner in a planar state;
a joining mechanism to join the support adhesive tape over the semiconductor wafer held by the chuck table and the ring frame; and
a tape separation mechanism to separate the double-faced adhesive tape from the semiconductor wafer integral with the ring frame via the adhesive tape.

6. The apparatus for mounting the semiconductor wafer according to claim 5, wherein
the separation table is configured so as to move from a removing position where the support substrate is to be removed to a wafer transporting position where the semiconductor wafer is to be transported to the wafer transport mechanism.

7. The apparatus for mounting the semiconductor wafer according to claim 5, wherein
the wafer transporting mechanism has a pressure plate to act on the semiconductor wafer;
the aligner has a detector to detect suction on the rear face of the semiconductor wafer, and a determination device to determine flatness of the semiconductor wafer in accordance with detected information from the detector and reference information set in advance; and
upon detection of warping in the semiconductor wafer with the determination device, the semiconductor wafer is corrected to be in a planar state by pressing the pressure plate of the wafer transporting mechanism against the semiconductor wafer.

8. The apparatus for mounting the semiconductor wafer according to claim 5, wherein
at least one of the adhesion layers in the double-faced adhesive tape is formed with an adhesive of thermal foam, and the substrate removing device has a heater for heating the double-faced adhesive tape.
